(19) United States
(12) Patent Application Publication
(10) Pub. No.: US 2013/0196886 A1
(43) Pub. Date: Aug. 1, 2013

(54) SURFACTANT SYSTEMS FOR ENHANCED OIL RECOVERY

(71) Applicants: Julian Richard Barnes, HW Amsterdam (NL); George J. Hirasaki, Bellaire, TX (US); Clarence A. Miller, Houston, TX (US); Maura Puerto, Houston, TX (US)

(72) Inventors: Julian Richard Barnes, HW Amsterdam (NL); George J. Hirasaki, Bellaire, TX (US); Clarence A. Miller, Houston, TX (US); Maura Puerto, Houston, TX (US)

(21) Appl. No.: 13/578,638

(22) PCT Filed: Feb. 10, 2011
(86) PCT No.: PCT/EP2011/051919

§ 371 Date: Oct. 5, 2012

Related U.S. Application Data
(60) Provisional application No. 61/304,692, filed on Feb. 15, 2010.

(51) Int. Cl. C09K 8/584

(52) U.S. Cl. CPC C09K 8/584
USPC 507/255

(57) ABSTRACT

The invention relates to a hydrocarbon recovery composition comprising a combination of an internal olefin sulfonate and an alkoxy glycidyl sulfonate, more specifically a hydrocarbon recovery composition comprising surfactant and water, wherein the surfactant comprises a combination of an internal olefin sulfonate with a chain length of greater than C20 and an alkoxy glycidyl sulfonate selected from an ethoxylated glycidyl sulfonate and a propoxylated glycidyl sulfonate. Further, the invention relates to a method of treating a hydrocarbon containing formation, comprising (a) providing a hydrocarbon recovery composition to at least a portion of the hydrocarbon containing formation, wherein the composition comprises a blend of an internal olefin sulfonate and an alkoxy glycidyl sulfonate; and (b) allowing the composition to interact with hydrocarbons in the hydrocarbon containing formation.

### FIELD

The present invention generally relates to methods for recovery of hydrocarbons from hydrocarbon formations. More particularly, embodiments described herein relate to methods of enhanced hydrocarbons recovery and to compositions useful therein which are specifically designed for use in hydrocarbon formations wherein the reservoir conditions, such as salinity, water hardness and temperature, are relatively severe.

### BACKGROUND

When an oil field reaches the end of its normal life, the bulk of its oil (as much as two-thirds) is still left in the ground because it is too difficult or too expensive to extract. It is estimated that by recovering just 1% extra throughout the world would equate to 20-30 billion barrels of oil—oil that may have been left behind.

There are three phases of oil recovery in a field: primary, secondary and tertiary. The primary phase is essentially drilling wells and allowing the natural pressure of the reservoir push the oil out. Any intervention in the primary phase is minor, such as providing artificial lift to encourage flow in the producing well such as via the use of ‘nodding donkeys’. In the secondary phase intervention increases, predominantly focussing on methods for maintaining the reservoir's pressure when the ability of the reservoir to do this on its own is insufficient. Secondary methods include injecting water into the reservoir or by reinjecting produced natural gas. The tertiary phase is where other fluids or gasses are injected to enhance the oil recovery and is therefore often referred to as EOR.

In chemical EOR the mobilization of residual oil saturation is achieved through surfactants which generate a sufficiently (ultra) low crude oil/water interfacial tension (IFT) to give a capillary number large enough to overcome capillary forces and allow the oil to flow (I. Chatzis and N. R. Morrows, “Correlation of capillary number relationship for sandstone”. SPE Journal, Vol 29, pp 555-562, 1989). However, reservoirs have different characteristics (crude oil type, temperature and the water composition—salinity, hardness) and it is desirable that the structures of added surfactant(s) be matched to these conditions to achieve a low IFT. In addition, a promising surfactant must fulfil other important criteria including low rock retention, compatibility with polymer, thermal and hydrolytic stability and acceptable cost.

Compositions and methods for enhanced hydrocarbons recovery utilizing an alpha olefin sulfate-containing surfactant component are known. U.S. Pat. Nos. 4,488,976 and 4,537,253 describe enhanced oil or recovery compositions containing such a component. Compositions and methods for enhanced hydrocarbons recovery utilizing internal olefin sulfonates are also known. Such a surfactant composition is described in U.S. Pat. No. 4,597,879. The compositions described in the foregoing patents have the disadvantages that brine solubility and divalent ion tolerances are insufficient at certain reservoir conditions. Furthermore, it would be advantageous if the IFT which can be achieved in relatively severe salinity and hardness conditions could be improved. U.S. Pat. No. 4,979,564 describes the use of internal olefin sulfonates in a method for enhanced oil recovery using low-tension viscous water flood. An example of a commercially available material described as being useful was ENORDET IOS 1720, a product of Shell Oil Company identified as a sulfonated C17-20 internal olefin sodium salt. This material has a low degree of branching. U.S. Pat. No. 5,068,043 describes a petroleum acid soap-containing surfactant system for waterflooding wherein a cosurfactant comprising a C17-20 or a C20-24 internal olefin sulfonate was used. In “Field Test of Cosurfactant-enhanced Alkaline Flooding” by Falls et al., Society of Petroleum Engineers Reservoir Engineering, 1994, the authors describe the use of a C17-20 or a C20-24 internal olefin sulfonate in a waterflooding composition with an alcohol alkoxylate surfactant to keep the composition as a single phase at ambient temperature without affecting performance at reservoir temperature significantly. The water had a salinity of about 0.4 wt % sodium chloride. These materials, used individually, also have disadvantages under relatively severe conditions of salinity and hardness.

Many reservoirs suitable for surfactant EOR have high temperatures and salinities, i.e., temperatures ranging from 70° C. to more than 120° C. and brines with substantial hardness and having total dissolved solids (TDS) contents up to about 200,000 mg/L. These conditions are challenging for process design because injected surfactants must remain chemically stable at reservoir conditions for the duration of the project, which could last for years. Moreover, precipitation or other undesirable phase separation must be avoided. In addition to meeting these conditions surfactants should be able to develop ultralow IFTs with crude oil at reservoir conditions, have low adsorption on reservoir rock, and form clear, single-phase aqueous solutions at mixing and injection temperatures, typically at surface temperature. In non water-wet formations they should also be able to increase wettability of pore surfaces to water.

### SUMMARY

In a first aspect the invention provides a hydrocarbon recovery composition comprising a combination of an internal olefin sulfonate (IOS) and an alkoxy glycidyl sulfonate (AGS). The composition of the invention shows a significant advantage in improving the solubility of surfactant systems under aqueous conditions but without compromising the ability to enhance oil recovery in reservoir conditions of high temperature and salinity.

In specific embodiments of the invention the IOS is selected from one or more IOS having a chain length selected from the group consisting of: C15-C18; C20-C24; and C24-C28. Suitably the IOS has a chain length of greater than C20.

In specific embodiments of the invention the AGS is an ethoxylated glycidyl sulfonate, suitably with an ethoxylated glycidyl sulfonate with an ethoxy chain length of between 1 and 9. In an alternative embodiment of the invention, the AGS is a propoxylated glycidyl sulfonate, suitably with a propoxy chain length of between 1 and 6.

In an embodiment of the invention the AGS is selected from one or more AGS having an alcohol hydrophobe chain length selected from the group consisting of: C12,13; C12-15; and C16,17. Optionally, the AGS can be selected from one or more of the group selected from: a C12,13 linear alcohol-ethoxy-3 glycidyl sulfonate; a C12-15 linear alcohol-ethoxy-7 glycidyl sulfonate a C16,17 branched alcohol-ethoxy-3 glycidyl sulfonate; a C16,17 branched alcohol-ethoxy-9 glycidyl sulfonate; C12,13 linear alcohol-propoxy-3 glycidyl sulfonate; C12,13 linear alcohol-propoxy-7 glycidyl sulfonate; and C16,17 branched alcohol-propoxy-3 glycidyl sulfonate.

In a particular embodiment the composition of the invention comprises the ratio of IOS to AGS of between about 60:40 and about 20:80% w/w. Optionally the ratio is between about 50:50 and about 20:80% w/w, or between about 45:55 and about 20:80% w/w. In a specific embodiment, the ratio of IOS to AGS in the composition is about 40:60% w/w.

In an embodiment of the invention the composition further comprises water, optionally sea water or higher salinity brine.

In a further aspect the invention provides a hydrocarbon recovery composition comprising surfactant and water, wherein the surfactant comprises a combination of an internal olefin sulfonate (IOS) with a chain length of greater than C20 and an alkoxy glycidyl sulfonate (AGS) selected from an ethoxylated glycidyl sulfonate and a propoxylated glycidyl sulfonate.

In specific embodiments of the invention the surfactant is present at a concentration of between about 0.01% and about 5.0% (w/v), suitably between about 0.1% and about 3.0% (w/v), optionally between about 1.0% and 5.0% (w/v).

A further aspect of the invention provides a method of treating a hydrocarbon containing formation, comprising:
(a) providing a hydrocarbon recovery composition to at least a portion of the hydrocarbon containing formation, wherein the composition comprises a blend of an internal olefin sulfonate (IOS) and an alkoxy glycidyl sulfonate (AGS); and
(b) allowing the composition to interact with hydrocarbons in the hydrocarbon containing formation.

In specific embodiments of the invention the temperature within the hydrocarbon containing formation is between about 65° C. and about 130° C., optionally between about 85° C. and about 120° C.

In a further embodiment of the invention the salinity of the hydrocarbon containing formation is between about 1% and about 20%, optionally between about 2% and about 15%.

Further aspects of the invention also provide for a surfactant system suitable for use in hydrocarbon recovery processes comprising a combination of an internal olefin sulfonate (IOS) and an alkoxy glycidyl sulfonate (AGS), together with apparatus suitable for performing the method of the invention as described above.

### DRAWINGS

The invention is further illustrated by the accompanying drawings in which:

FIG. 1 shows an optimal salinity map for AGS against n-octane at 120° C. The number of EO or PO groups in the linker are shown on the X axis, whilst optimal salinity (Cø) as % NaCl concentration is shown on the Y axis. The size of the alcohol hydrophobe group is denoted by the starting alcohol in which N23 corresponds to a C12,13 chain, N25 a C12-15 chain and N67 a C16, 17 chain.

FIG. 2 (a) is a photograph of a salinity scan at 120° C. for 4 wt % aqueous solutions of the AGS b-C16,17-9EO GS equilibrated with equal volumes of n-octane in the absence of alcohol. The solubilization parameters are set out in a graph (b).

FIG. 3 is a graph showing the effect of temperature on Cø of b-C16,17-9EO GS, (open triangles) and C12-15-7EO GS (closed triangles) with n-octane at 120° C. The optimal salinity, Cø, decreases approximately 0.15% NaCl/° C.

FIG. 4 (a) is a photograph of a salinity scan at 120° C. for 2 wt % aqueous solutions of the AGS C12,13-3EO GS n-octane at 120° C. equilibrated with equal volumes of n-octane in the absence of alcohol. horizontal white bars have been added to indicate interfacial positions. The solubilization parameters are set out in a graph (b).

FIG. 5 (a) is series of photographs at various times after removal from oil bath of a Sample from a 2% C12-15-7EO GS salinity scan with n-octane (a water to oil ratio of about 1:1) at 19.8% NaCl and 120° C. A plot of solubilization parameters is also shown (b).

FIG. 6 shows graphs of the solubilization parameters for salinity scans of 2% b-C16,17-3PO GS with octane at 95° C. (a) and 130° C. (b). Cø is independent of temperature in this range.

FIG. 7 shows a plot demonstrating that Cø decreases with increasing PO chain length for a fixed hydrophobe (b-C16,17) and constant temperature (PO number for b-C16,17-POx GS, where x=3, 7 and 9)

FIG. 8 shows photographs of a salinity scan at scan at 110° C. for 2% b-C16,17-7PO GS with an equal volume of n-Octane, (a) at 2% NaCl, a waxy high-viscosity phase is apparent (indicated by A), (b) shows the salinity scan of between 1 and 5% NaCl.

FIG. 9 shows salinity maps (a) and (b) for two IOS C20-24 preparations.

FIG. 10 shows photographs of salinity scans at temperatures indicated for IOS C20-24 with n-octane.

FIG. 11 shows plots of optimal salinities (a) and optimal solubilization (b) parameters for 4 IOS surfactants (IOSa—closed diamonds; IOSb—open diamonds; IOSc—closed square; IOSd—closed triangles) with comparable average chain lengths (between C20-24).

FIG. 12 (a) shows photograph of a blend scan with n-octane at 90° C. for b-C16,17-9EO GS and IOS C20-24 at 2% w/v in synthetic seawater. (b) shows a plot of the solubilization parameters.

FIG. 13 is a solubility map of blends of C16,17-9EO GS and IOS 2024 in synthetic sea water.

### DETAILED DESCRIPTION

All references cited herein are incorporated by reference in their entirety. Unless otherwise defined, all technical and scientific terms used herein have the same meaning as commonly understood by one of ordinary skill in the art to which this invention belongs.

In order to assist with the understanding of the invention several terms are defined herein.

The internal olefin sulfonates used in the present invention are synthesised as described in van Os N. M et al. “Anionic Surfactants: Organic Chemistry” Surfactant Science Series 56, ed. Stacke H. W., (1996) Chapter 7: olefinsulfonates, p 363. The IOS of the invention are characterised by their average carbon number which is determined by multiplying the number of carbon atoms of each IOS in the blend by the weight percent of that IOS and then adding the products. The IOS used in the invention typically are synthesised from olefins with carbon length cuts of C15-C18, C20-24 and C24-28 which are then sulfonated, for example, via a laboratory based falling film method. Hence, “C15-18 internal olefin sulfonate” as used herein means a heterogeneous blend of IOS with an average carbon number of from 16 to 17 and at least 50% by weight, preferably at least 75% by weight, most preferably at least 90% by weight, of the IOS in the blend contain from 15 to 18 carbon atoms. “C20-C24 internal olefin sulfonate” as used herein means a blend of IOS wherein the blend has an average carbon number of from 20.5 to 23 and at least 50% by weight, preferably at least 65% by weight, most preferably at least 75% by weight, of the internal olefin sulfonates in the blend contain from 20 to 24 carbon atoms. Likewise “C24-C28 internal olefin sulfonate” as used herein means a blend of IOS wherein the blend has an average carbon number of from 25 to 27 and at least 50% by weight, preferably at least 60% by weight, most preferably at least 65% by weight, of the IOS in the blend contain from 24 to 28 carbon atoms. IOS suitable for use in the invention include the ENORDET™ O range of surfactants (Shell Chemicals Company).

The term “alkoxy glycidyl sulfonate (AGS)” as used herein refers to the sulfonate derivative of an alcohol alkoxylate. The alcohol alkoxylate is prepared via either the ethoxylation (EO) or propoxylation (PO) of an alcohol using conventional techniques that are known to the skilled person.

AGSs are suitably synthesised from branched alcohols such as C16,17 alcohol (e.g. NEODOL™ 67 alcohol, Shell Chemicals Company) which contributes the hydrophobe component of the molecule. The sulfonate end group is linked to the hydrophobe via one or more ethylene oxide (EO) or propylene oxide (PO) linking groups. Suitable AGSs for use in the invention can comprise between about 1 and about 9 EO or PO linking groups per molecule. However, it will be understood by the person skilled in the art that the values given for the number of EO or PO linking groups represent an average number within the composition as a whole. AGSs suitable for use in the invention include the ENORDET™ A range of anionic surfactants (Shell Chemicals Company).

In a specific embodiment of the invention, described in more detail below, AGSs were prepared from three commercially available primary alcohols: C12,13 alcohol, C12-15 alcohol (both composed of approximately 80% linear alcohol and 20% branching on the C2 carbon) and C16,17 alcohol (fully methyl branched with an 1-1.5 branches per molecule). In terms of abbreviations used herein, b-C16, 17-3EO GS stands for branched C16, 17 alcohol with 3 ethylene oxide groups and a terminal glycidyl sulfonate group and C12,13-3PO GS for (largely) linear C12,13 alcohol with 3 propylene oxide groups and a terminal GS group.

A limitation of compositions that contain solely an alkoxylated sulfonate surfactant is that, like alkoxylated nonionic surfactants, their aqueous solutions typically exhibit a cloud point, i.e., separation into two liquid phases as temperature increases. Thus formulations using alkoxylated sulfonates alone, while exhibiting favorable phase behavior with oil, may be unsuitable as injectable compositions for EOR. IOSs exhibit the opposite behavior, becoming more soluble in aqueous solutions as temperature increases. Accordingly, their blends with alkoxylated sulfonates offer prospects of having single-phase aqueous solutions over a wider temperature interval, from surface to reservoir temperature, than alkoxylated sulfonates alone. Moreover, the alkoxylated sulfonates in such blends can provide tolerance to high TDS contents and hardness. The present invention provides such behavior showing that suitable blends of this type are surprisingly promising for use in EOR processes in high-temperature, high-salinity reservoirs.

Suitable AGS surfactants for use in the compositions and methods of the invention include, but are not limited to, those selected from: a C12,13 linear alcohol-ethoxy-3 glycidyl sulfonate; a C12-15 linear alcohol-ethoxy-7 glycidyl sulfonate a C16,17 branched alcohol-ethoxy-3 glycidyl sulfonate; a C16,17 branched alcohol-ethoxy-9 glycidyl sulfonate; C12,13 linear alcohol-propoxy-3 glycidyl sulfonate; C12,13 linear alcohol-propoxy-7 glycidyl sulfonate; and C16,17 branched alcohol-propoxy-3 glycidyl sulfonate

Hydrocarbons may be produced from hydrocarbon formations through wells penetrating a hydrocarbon containing formation. “Hydrocarbons” are generally defined as molecules formed primarily of carbon and hydrogen atoms such as oil and natural gas. Hydrocarbons may also include other elements, such as, but not limited to, halogens, metallic elements, nitrogen, oxygen and/or sulfur. Hydrocarbons derived from a hydrocarbon formation may include, but are not limited to, kerogen, bitumen, pyrobitumen, asphaltenes, oils or combinations thereof. Hydrocarbons may be located within or adjacent to mineral matrices within the earth. Matrices may include, but are not limited to, sedimentary rock, sands, silicilytes, carbonates, diatomites and other porous media.

A “formation” includes one or more hydrocarbon containing layers, one or more non-hydrocarbon layers, an overburden and/or an underburden. An “overburden” and/or an “underburden” includes one or more different types of impermeable materials. For example, overburden/underburden may include rock, shale, mudstone, or wet/tight carbonate (i.e., an impermeable carbonate without hydrocarbons). For example, an underburden may contain shale or mudstone. In some cases, the overburden/underburden may be somewhat permeable. For example, an underburden may be composed of a permeable mineral such as sandstone or limestone. In some embodiments, at least a portion of a hydrocarbon containing formation may exist at less than or more than 1000 feet below the earth's surface.

Properties of a hydrocarbon containing formation may affect how hydrocarbons flow through an underburden/overburden to one or more production wells. Properties include, but are not limited to, porosity, permeability, pore size distribution, surface area, salinity or temperature of formation. Overburden/underburden properties in combination with hydrocarbon properties, such as, capillary pressure (static) characteristics and relative permeability (flow) characteristics may effect mobilization of hydrocarbons through the hydrocarbon containing formation. Permeability of a hydrocarbon containing formation may vary depending on the formation composition. A relatively permeable formation may include heavy hydrocarbons entrained in, for example, sand or carbonate. “Relatively permeable,” as used herein, refers to formations or portions thereof, that have an average permeability of 10 millidarcy or more. “Relatively low permeability” as used herein, refers to formations or portions thereof that have an average permeability of less than about 10 millidarcy. One darcy is equal to about 0.99 square micrometers. An impermeable portion of a formation generally has a permeability of less than about 0.1 millidarcy. In some cases, a portion or all of a hydrocarbon portion of a relatively permeable formation may include predominantly heavy hydrocarbons and/or tar with no supporting mineral grain framework and only floating (or no) mineral matter (e.g., asphalt lakes).

Fluids (e.g., gas, water, hydrocarbons or combinations thereof) of different densities may exist in a hydrocarbon containing formation. A mixture of fluids in the hydrocarbon containing formation may form layers between an underburden and an overburden according to fluid density. Gas may form a top layer, hydrocarbons may form a middle layer and water may form a bottom layer in the hydrocarbon containing formation. The fluids may be present in the hydrocarbon containing formation in various amounts. Interactions between the fluids in the formation may create interfaces or boundaries between the fluids. Interfaces or boundaries between the fluids and the formation may be created through interactions between the fluids and the formation. Typically, gases do not form boundaries with other fluids in a hydrocarbon containing formation. In an embodiment, a first boundary may form between a water layer and underburden. A second boundary may form between a water layer and a hydrocarbon layer. A third boundary may form between hydrocarbons of different densities in a hydrocarbon containing formation. Multiple fluids with multiple boundaries may be present in a hydrocarbon containing formation, in some embodiments. It should be understood that many combinations of boundaries between fluids and between fluids and the overburden/underburden may be present in a hydrocarbon containing formation.

Production of fluids may perturb the interaction between fluids and between fluids and the overburden/underburden. As fluids are removed from the hydrocarbon containing formation, the different fluid layers may mix and form mixed fluid layers. The mixed fluids may have different interactions at the fluid boundaries. Depending on the interactions at the boundaries of the mixed fluids, production of hydrocarbons may become difficult. Quantification of the interactions (e.g., energy level) at the interface of the fluids and/or fluids and overburden/underburden may be useful to predict mobilization of hydrocarbons through the hydrocarbon containing formation.

Quantification of energy required for interactions (e.g., mixing) between fluids within a formation at an interface may be difficult to measure. Quantification of energy levels at an interface between fluids may be determined by generally known techniques (e.g., spinning drop tensiometer). Interaction energy requirements at an interface may be referred to as interfacial tension. “Interfacial tension” (IFT) as used herein, refers to a surface free energy that exists between two or more fluids that exhibit a boundary. A high interfacial tension value (e.g., greater than about 10 dynes/cm) may indicate the inability of one fluid to mix with a second fluid to form a fluid emulsion. As used herein, an “emulsion” refers to a dispersion of one immiscible fluid into a second fluid by addition of a composition that reduces the interfacial tension between the fluids to achieve stability. The inability of the fluids to mix may be due to high surface interaction energy between the two fluids. Low interfacial tension values (e.g., less than about 1 dyne/cm) may indicate less surface interaction between the two immiscible fluids. Less surface interaction energy between two immiscible fluids may result in the mixing of the two fluids to form an emulsion. Fluids with low interfacial tension values may be mobilized to a well bore due to reduced capillary forces and subsequently produced from a hydrocarbon containing formation. Fluids in a hydrocarbon containing formation may wet (e.g., adhere to an overburden/underburden or spread onto an overburden/underburden in a hydrocarbon containing formation). As used herein, “wettability” refers to the preference of a fluid to spread on or adhere to a solid surface in a formation in the presence of other fluids. Methods to determine wettability of a hydrocarbon formation are described by Craig, Jr. in “The Reservoir Engineering Aspects of Waterflooding”, 1971 Monograph Volume 3, Society of Petroleum Engineers, which is herein incorporated by reference. In an embodiment, hydrocarbons may adhere to sandstone in the presence of gas or water. An overburden/underburden that is substantially coated by hydrocarbons may be referred to as “oil wet.” An overburden/underburden may be oil wet due to the presence of polar and/or heavy hydrocarbons (e.g., asphaltenes) in the hydrocarbon containing formation. Formation composition (e.g., silica, carbonate or clay) may determine the amount of adsorption of hydrocarbons on the surface of an overburden/underburden. In some embodiments, a porous and/or permeable formation may allow hydrocarbons to more easily wet the overburden/underburden. A substantially oil wet overburden/underburden may inhibit hydrocarbon production from the hydrocarbon containing formation. In certain embodiments, an oil wet portion of a hydrocarbon containing formation may be located at less than or more than 1000 feet below the earth's surface.

A hydrocarbon formation may include water. Water may interact with the surface of the underburden. As used herein, “water wet ” refers to the formation of a coat of water on the surface of the overburden/underburden. A water wet overburden/underburden may enhance hydrocarbon production from the formation by preventing hydrocarbons from wetting the overburden/underburden. In certain embodiments, a water wet portion of a hydrocarbon containing formation may include minor amounts of polar and/or heavy hydrocarbons.

Water in a hydrocarbon containing formation may contain minerals (e.g., minerals containing barium, calcium, or magnesium) and mineral salts (e.g., sodium chloride, potassium chloride, magnesium chloride). Water salinity and/or water hardness of water in a formation may affect recovery of hydrocarbons in a hydrocarbon containing formation. As used herein “salinity” refers to an amount of dissolved solids in water. “Water hardness,” as used herein, refers to a concentration of divalent ions (e.g., calcium, magnesium) in the water. Water salinity and hardness may be determined by generally known methods (e.g., conductivity, titration). As water salinity increases in a hydrocarbon containing formation, interfacial tensions between hydrocarbons and water may be increased and the fluids may become more difficult to produce.

A hydrocarbon containing formation may be selected for treatment based on factors such as, but not limited to, thickness of hydrocarbon containing layers within the formation, assessed liquid production content, location of the formation, salinity content of the formation, temperature of the formation, and depth of hydrocarbon containing layers. Initially, natural formation pressure and temperature may be sufficient to cause hydrocarbons to flow into well bores and out to the surface. Temperatures in a hydrocarbon containing formation may range from about 0° C. to about 300° C. As hydrocarbons are produced from a hydrocarbon containing formation, pressures and/or temperatures within the formation may decline. Various forms of artificial lift (e.g., pumps, gas injection) and/or heating may be employed to continue to produce hydrocarbons from the hydrocarbon containing formation. Production of desired hydrocarbons from the hydrocarbon containing formation may become uneconomical as hydrocarbons are depleted from the formation.

Mobilization of residual hydrocarbons retained in a hydrocarbon containing formation may be difficult due to viscosity of the hydrocarbons and capillary effects of fluids in pores of the hydrocarbon containing formation. As used herein “capillary forces” refers to attractive forces between fluids and at least a portion of the hydrocarbon containing formation. In an embodiment, capillary forces may be overcome by increasing the pressures within a hydrocarbon containing formation. In other embodiments, capillary forces may be overcome by reducing the interfacial tension between fluids in a hydrocarbon containing formation. The ability to reduce the capillary forces in a hydrocarbon containing formation may depend on a number of factors, including, but not limited to, the temperature of the hydrocarbon containing formation, the salinity of water in the hydrocarbon containing formation, and the composition of the hydrocarbons in the hydrocarbon containing formation.

As production rates decrease, additional methods may be employed to make a hydrocarbon containing formation more economically viable. Methods may include adding sources of water (e.g., brine, steam), gases, polymers, monomers or any combinations thereof to the hydrocarbon formation to increase mobilization of hydrocarbons.

In an embodiment of a method to treat a hydrocarbon containing formation, a hydrocarbon recovery composition including a branched olefin sulfonate may be provided (e.g., injected) into hydrocarbon containing formation through an injection well. The hydrocarbon formation may include an overburden, a hydrocarbon layer, and underburden. The injection well may include additional openings that allow fluids to flow through hydrocarbon containing formation at various depth levels.

A hydrocarbon recovery composition may be provided to the formation in an amount based on hydrocarbons present in a hydrocarbon containing formation. The amount of hydrocarbon recovery composition, however, may be too small to be accurately delivered to the hydrocarbon containing formation using known delivery techniques (e.g., pumps). To facilitate delivery of small amounts of the hydrocarbon recovery composition to the hydrocarbon containing formation, the hydrocarbon recovery composition of the invention may be combined with water and/or brine to produce an injectable fluid.

The invention is further illustrated in the following non-limiting example.

### EXAMPLE

1. Introduction

It is known that surfactants with alkoxy chains, i.e., ethylene oxide (EO) and/or propylene oxide (PO), can improve surfactant tolerance to high salinities and hardness. Indeed, sulfates having EO and/or PO groups have been used in laboratory and pilot tests of surfactant EOR processes at low temperatures (Adams, W. T., Schievelbein, V. H. 1987 Surfactant flooding carbonate reservoirs, SPERE 2(4), 619-626; Maerker, J. M. and Gale, W. W. 1992. Surfactant flood process design for Loudon, SPERE, 7, 36-44; Liu, S., Zhang, D. L., Yan, W., Puerto, M., Hirasaki, G. J., Miller, C. A. 2008 Favorable attributes of alkali-surfactant-polymer flooding, SPEJ 13(1), 5-16; Levitt, D. B., Jackson, A. C., Heinson, C., Britton, L. N., Malik, T., Varadarajan, D., and Pope, G. A. 2006 Identification and evaluation of high-performance EOR surfactants, SPE 100089, presented at Symp. on IOR, Tulsa).

However, sulfates have a sulfur-to-oxygen bond, which is subject to hydrolysis at high temperatures (Talley, L. D. 1988 Hydrolytic stability of alkylethoxy sulfates, SPERE 3(1), 235-242). Efforts are being made to identify particular conditions where hydrolysis can be minimized as well as additives which can help achieve these conditions. Nevertheless great caution should be exercised in laboratory screening for using sulfates above 50° C.-60° C. Test results should indicate clearly that surfactant stability can be maintained for the entire range of conditions encountered during the designed EIOR process. In contrast, sulfonates, including those with alkoxy groups, have the required stability at high temperatures because they have a sulfur-to-carbon bond, which is not subject to hydrolysis.

Results for several internal olefin sulfonates (IOSs) showing phase behavior expected to yield ultralow IFTs at high temperatures have been presented previously (Barnes, J. R., Smit, J. P., Smit, J. R., Shpakoff, P. G., Raney, K. H., Puerto, M. C., 2008 Development of surfactants for chemical flooding at difficult reservoir conditions, SPE 113313 presented at Symp. on IOR, Tulsa, Okla.). Further performance data regarding these surfactants is provided herein in brines containing only NaCl, i.e., no hardness. EOR processes in reservoirs with brines having substantial hardness and high values of TDS will likely require the use of alkoxylated surfactants.

Processes for making alkoxylated sulfonates are more complex and hence more expensive than those for making alkoxylated sulfates. This present invention deals with alkoxylated glycidyl sulfonates (AGSs), whose synthesis and structure were described by Barnes et al (2008). Some core flooding experiments using such surfactants were carried out by Wellington and Richardson (Wellington, S. L., Richardson, E. A. 1997 SPEJ 2, 389) but not at high temperatures and salinities that are often found in hydrocarbon formations designated for EOR. Phase behavior of some individual surfactants of this type is shown below for temperatures up to 120° C. in model systems with n-octane as the oil and NaCl brine. Octane was chosen because its optimal salinities with various surfactants are not greatly different from those of the same surfactants with many crude oils (Cayias, J. L., Schechter, R. S., Wade, W. H. 1976 Modeling crude oils for low interfacial tensions, SPEJ 16(6), 351-357; Nelson, R. C. 1983 The effect of live crude on phase behavior and oil-recovery efficiency of surfactant flooding systems, SPEJ 23(3), 501-510). However, solubilization parameters at optimal conditions are lower for crude oils than for octane which has a lower molar volume (Puerto, M. C. and Reed, R. L. 1983 A three-parameter representation of surfactant/oil/brine interaction, SPEJ 23(4), 669-682). Hence interfacial tensions are higher. In this paper a plot is given showing optimal salinities and solubilization parameters for several AGSs at 120° C. as a function of lengths of the hydrophobe and of EO or PO chains. It provides a useful starting point for surfactant selection.

A limitation of alkoxylated sulfonates is that, like alkoxylated nonionic surfactants, their aqueous solutions typically exhibit a cloud point, i.e., separation into two liquid phases as temperature increases. Thus formulations using alkoxylated sulfonates alone, while exhibiting favorable phase behavior with oil, may be unsuitable as injectable compositions. IOSs exhibit the opposite behavior, becoming more soluble in aqueous solutions as temperature increases. Accordingly, their blends with alkoxylated sulfonates offer prospects of having single-phase aqueous solutions over a wider temperature interval, from surface to reservoir temperature, than alkoxylated sulfonates alone. Moreover, the alkoxylated sulfonates in such blends can provide tolerance to high TDS contents and hardness. We provide an example of such behavior showing that suitable blends of this type are promising for use in EOR processes in high-temperature, high-salinity reservoirs.

2. Experimental

Surfactants Synthesis and Their Structures

A description of the synthesis steps for AGS and IOS surfactants and the chemical structures formed were described earlier by Barnes et al (2008). The AGSs were prepared from three commercially available primary alcohols: C12,13 alcohol, C12-15 alcohol (both composed of 80% linear alcohol and 20% branching on the C2 carbon) and C16,17 alcohol (fully methyl branched with an average of 1.5 branches per molecule). In terms of abbreviations in this paper b-C16, 17-3EO GS stands for branched C16, 17 alcohol with 3 ethylene oxide groups and a terminal glycidyl sulfonate group and C12,13-3PO GS for (largely) linear C12, 13 alcohol with 3 propylene oxide groups and a terminal GS group. The IOSs were prepared from internal olefins with carbon cuts C20-24.

### Microemulsion Phase Tests

The procedure for sample preparation was previously disclosed and called the glass pipette method (Barnes et 2008). The volume of fluids required to accurately determine surfactant properties is about 2 cm3 and is contained in heat-sealed pipettes. The small pipettes were made from cutting disposable, 5 cm3 serological pipettes of borosilicate glass with 0.1 cm3 subdivisions having regular tip and standard length. The n-octane was 98% reagent grade. All surfactant samples were from Shell Chemicals Company.

Tests are carried out in oil baths. Water, oil and surfactant are weighed into pipettes using an analytical balance, taking into account their densities. Sealed pipettes, containing water/surfactant (1 cm³) and test oil (1 cm³) are placed inside a 10 cm³ test tube filled with the same fluid as in the bath. Samples are mixed in a rotisserie-type mixer immersed in the oil bath or shaken by hand. After being mixed, samples are left to equilibrate at test temperature. Photographs are taken at different time intervals.

There are advantages for inserting the sealed pipette in a test tube filled with the bath fluid: (1) If the sealed pipette leaks, test oil will be diluted by about 10 times, which mitigates the hazard of handling low molecular weight oils such as n-octane at high temperature (2) The presence of the outer liquid oil jacket will contain any leak or rupture of the glass pipette and prevent contamination of the bath fluid. (3) The outer hot fluid mitigates temperature losses. This makes it practicable to visualise and photograph surfactant phase behaviour at high temperatures.

3. Phase Behavior of Alkoxylated Glycidyl Sulfonate Solutions with Octane

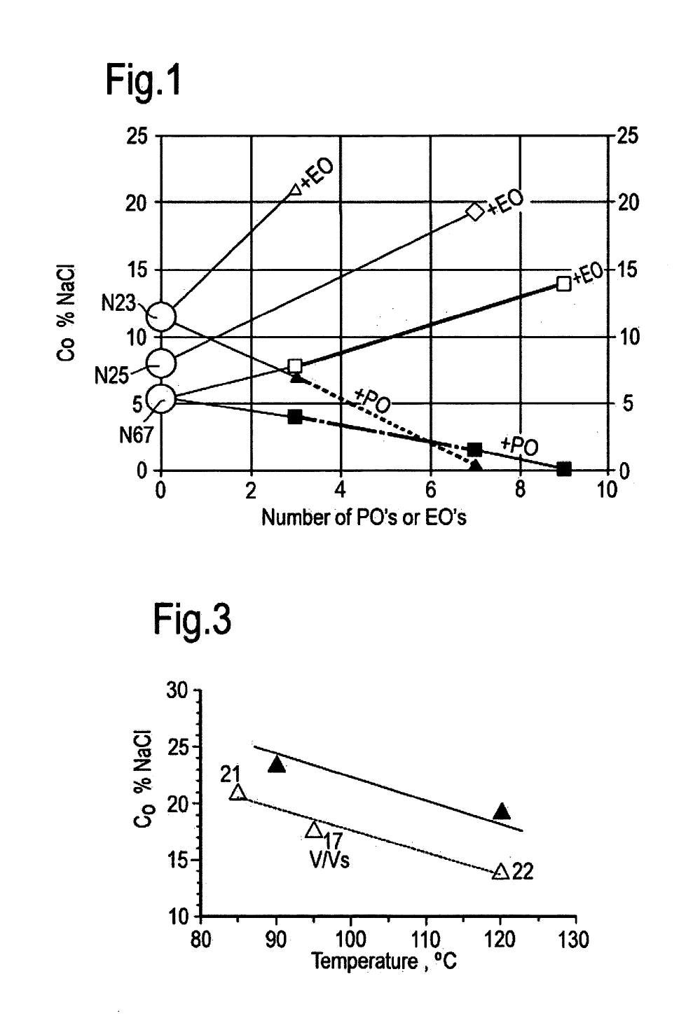

FIG. 1 shows optimal salinity (Cø) with octane at 120° C. as a function of alkoxy chain length for three alcohol series of AGSs. No alcohol or other co-solvent was used during the tests. As is evident, a wide range of C_{ø} values can be achieved by varying type and length of alkoxy chain and surfactant hydrophobe. C_{ø} increases with increasing EO chain length but decreases with increasing PO chain length. Longer-chain hydrophobes lead to lower C_{ø}. Although additional data might reveal that variation of C_{ø} with alkoxy chain length is not linear as indicated, the basic trends are clear.

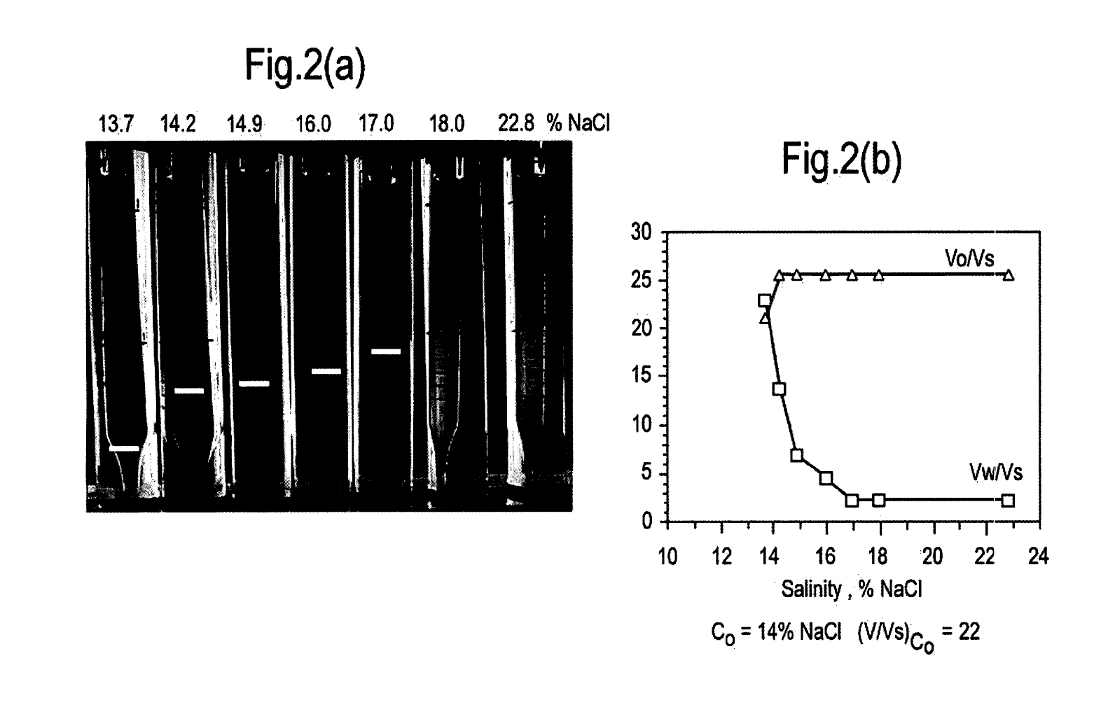

Maps such as FIG. 1 provide a starting point for selecting surfactants for use in EOR processes, in this case for an elevated reservoir temperature. Surfactants with different hydrophobes and alkoxy chain lengths from those used to construct the map could be selected to achieve desired values of C_{ø}. Indeed, two or more surfactants may have virtually the same C_{ø}, as shown for b-C16, 17-3EO GS and C12,13-3PO GS in FIG. 2. Another possibility is to blend surfactants of this type in suitable proportions, for instance one having C_{ø} above and another having C_{ø} below that of the reservoir. The following subsections present results on phase behavior including C_{ø} and solubilization parameters for individual surfactants and provide information on the effect of temperature in the range 85° C. to 120° C.

3.1 Ethoxylated Glycidyl Sulfonates

As depicted in FIG. 1, ethoxylated glycidyl sulfonates are potential candidates for EOR processes in high temperature, high salinity reservoirs. The ethoxylated surfactants exhibited optimal salinities with octane up to 21% NaCl at 120° C. EO chain lengths ranged from 3 to 9, and three hydrophobes were used based on C12, 13; C12-15 and C16, 17 alcohols.

FIG. 2 is a photograph of a salinity scan at 120° C. for 4 wt % aqueous solutions of b-C16,17-9EO GS equilibrated with equal volumes of n-octane in the absence of alcohol. The horizontal red bars indicate positions of interfaces difficult to see in the photograph. Transition from Winsor III to Winsor II (middle to upper) phase behavior is observed with increasing salinity. At lower salinities than shown, Winsor I (lower) phase behavior would be seen. Also included is a plot of solubilization parameters (Vo/Vs) and (Vw/Vs) for the scan, where Vo, Vw, and Vs are volumes of oil, brine and surfactant in the microemulsion phase, as estimated from phase volumes. Optimal salinity, C_{ø}, where the two solubilization parameters have equal values (V/Vs)Cø, is approximately 14% NaCl (w/v), as also shown for this surfactant in FIG. 2. The high value for (V/Vs)Cø of 22 suggests, according to Huh's correlation (Huh, C. 1979 Interfacial tensions and solubilizing ability of a microemulsion phase that coexists with oil and brine, J. Colloid Interface Sci. 71(2), 408-426), that interfacial tension (IFT) is ultralow near CØ and should provide high oil recovery in core floods. Indeed, values of (V/Vs)Cø exceeding 10 should lead to sufficiently low tensions for good recovery, a criterion met by all surfactants discussed in subsections 3.1 and 3.2 for the conditions cited.

The lower line of FIG. 3 shows that C_{ø} with n-octane for this surfactant decreases as temperature increases from 85° C. to 120° C., the slope being approximately 0.15% NaCl/° C. This trend is expected for surfactants with EO chains, which become less hydrated with increasing temperature. Values of (V/Vs)Cø remain high and exhibit little change over this temperature range.

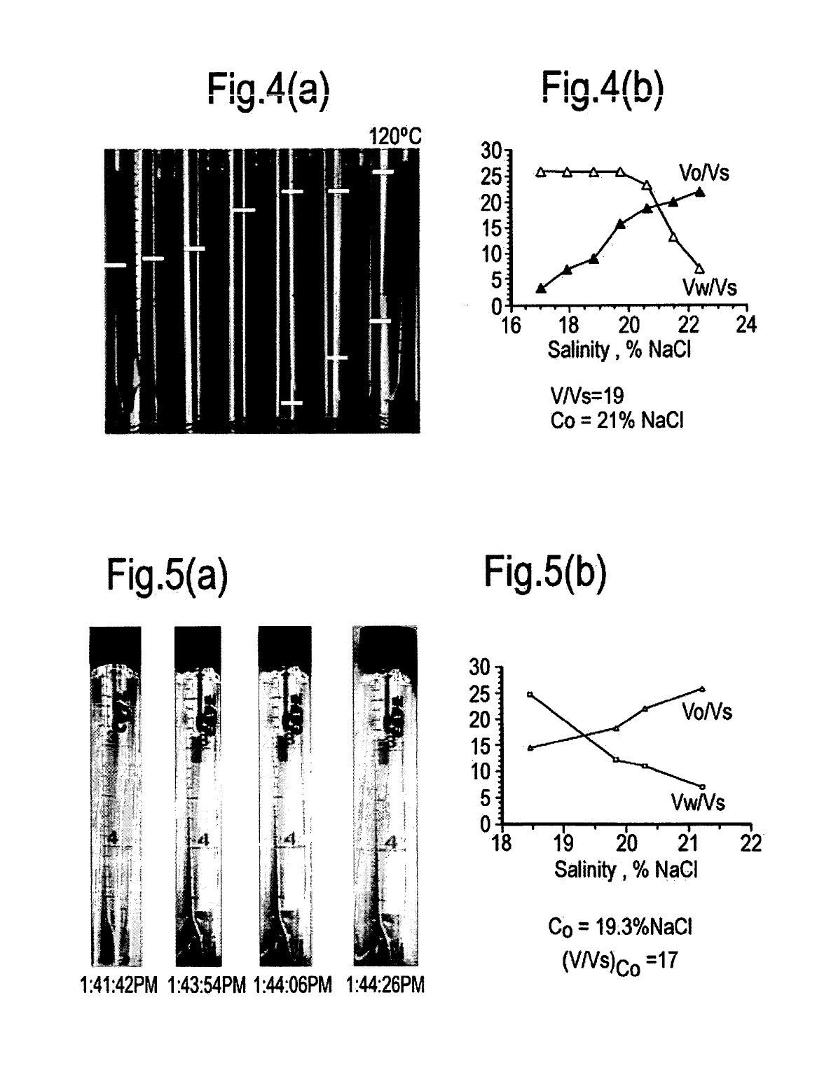

FIG. 4 is similar to FIG. 2 except that the surfactant is C12,13-3EO GS. Again the temperature is 120° C. and horizontal red bars have been added to indicate interfacial positions. In this case the scan includes Winsor I and III regions, but not Winsor II, which would occur at even higher salinities. C_{ø} is higher (21% NaCl) owing to the shorter chain length of the hydrophobe, which outweighs the tendency of the shorter EO chain length to decrease optimal salinity. Here too, a large value (19) for (V/Vs)Cø is found.

FIG. 5 shows dependence of solubilization parameters on salinity at 120° C. for the surfactant C12-15-7EO GS equilibrated with octane. The photographs of the sample at 19.8% NaCl for several times after removal from the oil bath illustrate another way of revealing the positions of interfaces that are difficult to see. On cooling, the microemulsion becomes supersaturated, and the resulting nucleation of small oil droplets causes this phase to become cloudy. C_{ø} is near 19% NaCl, which is intermediate between those of FIGS. 2 and 4 for longer-chain and shorter-chain hydrophobes respectively. (V/Vs)Cø is about 17, only slightly lower than for the two surfactants discussed previously. Variation of C_{ø} with temperature for this surfactant is shown by the upper line in FIG. 4. It decreases with increasing temperature, the slope being comparable to that of the lower line for b-C16,17-9EO GS discussed previously. Corresponding values of (V/Vs) Cø are also shown.

3.2 Propoxylated Glycidyl Sulfonates

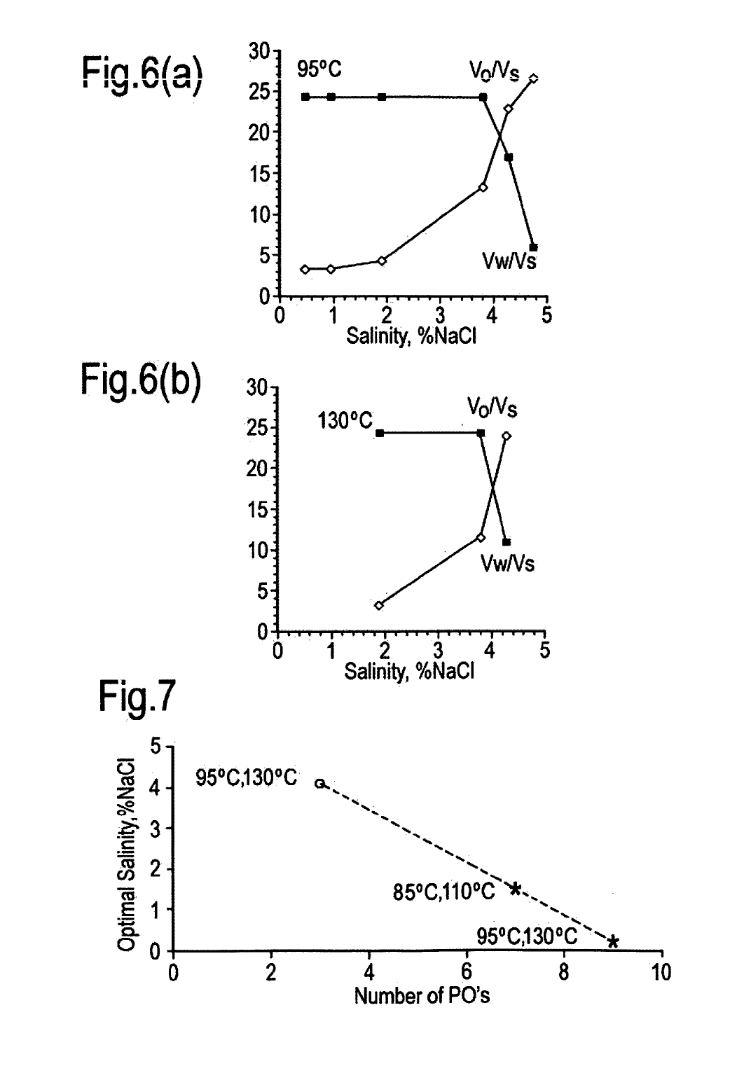

Plots of solubilization parameters as a function of salinity at 95° C. and 130° C. are shown in FIG. 6 for b-C16,173PO GS, again with octane as the oil. C_{ø} (where the two curves intersect) is about 4% NaCl in both cases, much lower than for the ethoxylated sulfonates shown in FIG. 3. However, (V/Vs) Co decreases slightly, from 19 at 95° C. to 16 at 130° C., remaining high enough to indicate good oil recovery.

C_{ø} decreases with increasing PO chain length for a fixed hydrophobe (b-C16,17) and constant temperature, as shown in FIG. 7.

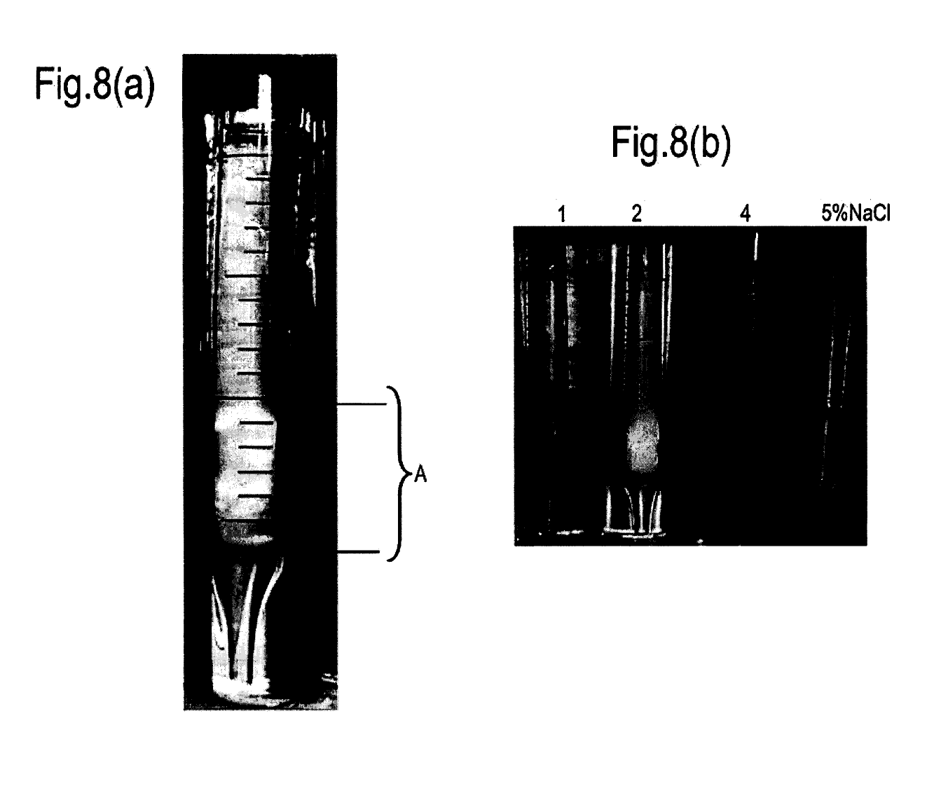

However, highly viscous phases were observed in the salinity scans for the surfactants with 7 and 9 POs. For instance, FIG. 8 shows the scan at 110° C. for b-C16,17-7PO GS. The volume of the aqueous phase at 1% NaCl is greater than its initial value, which suggests a lower phase microemulsion (Winsor I). Similarly the large volumes of the oleic phase at 4% and 5% NaCl are indicative of upper phase microemulsions (Winsor II). However, the surfactant-containing phase at 2% NaCl, shown in the inset, is not a microemulsion. Instead it is a highly viscous phase or dispersion that does not move when the pipette is gently tilted. These types of viscous phases have been called Very Condensed Phases or VCP's (Puerto and Reed, 1983). Similar viscous material was seen in the scan for b-C16,17-9PO GS.

Conventional Winsor behavior was observed with no highly viscous phases for the other propoxylated surfactants used to construct FIG. 1, C12,13-3PO GS and C12,13-7PO GS.

It should be mentioned that VCPs can be eliminated by alcohol addition, raising test temperature, increasing/decreasing oil molar volume of test oil (Puerto and Reed, 1983) or combinations of the above. As an example, the VCPs found in b-C16,17-9P0 GS when the test oil was n-octane were eliminated by changing the oil to n-hexadecane and increasing temperature to 130° C. This indicates that the lipophilic b-C16,17-9PO tail can be solvated by heavy crudes oils. However, addition of too many PO groups to a large lipophile, such as b-C16, 17, will yield a molecule that is extremely lipophilic at elevated temperatures and which is unsuitable for high salinity reservoirs.

4. Aqueous Surfactant Solutions of Alkoxylated Glycidyl Sulfonates and Internal Olefin Sulfonates

In addition to exhibiting suitable phase behavior with oil, the surfactant or surfactant blend for an economic EOR process should have an aqueous solution which is a single phase for injection conditions and which remains so until it enters the reservoir and contacts oil. Otherwise the surfactant may be distributed in a non-uniform and unpredictable manner in the reservoir. Typically this requirement means that single-phase conditions are required from a relatively low injection temperature to reservoir temperature, which may be much higher. If mixing with reservoir brine occurs before the injected solution contacts oil, it should remain a single phase for the combinations of salinity and temperature encountered.

Aqueous, oil-free solutions of AGSs are generally single-phase micellar solutions at low temperatures but separate into surfactant-rich and surfactant-lean liquid phases above a cloud point temperature, so called because of the appearance of droplets of the second phase causing the solution to appear cloudy. Clouding also occurs at constant temperature with increasing salinity. This behavior is similar to that of nonionic surfactants with alkoxy chains.

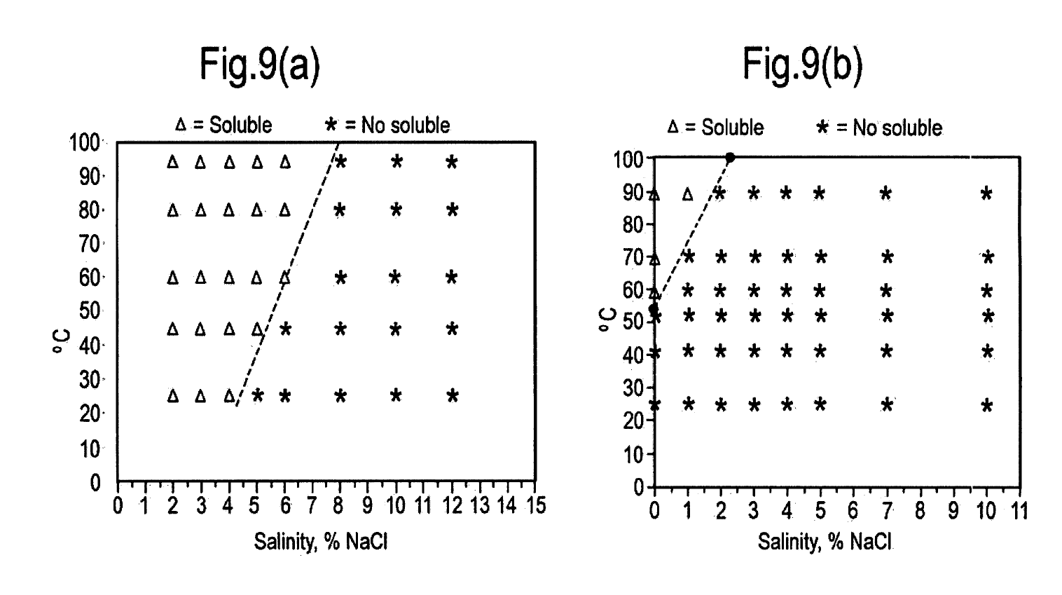

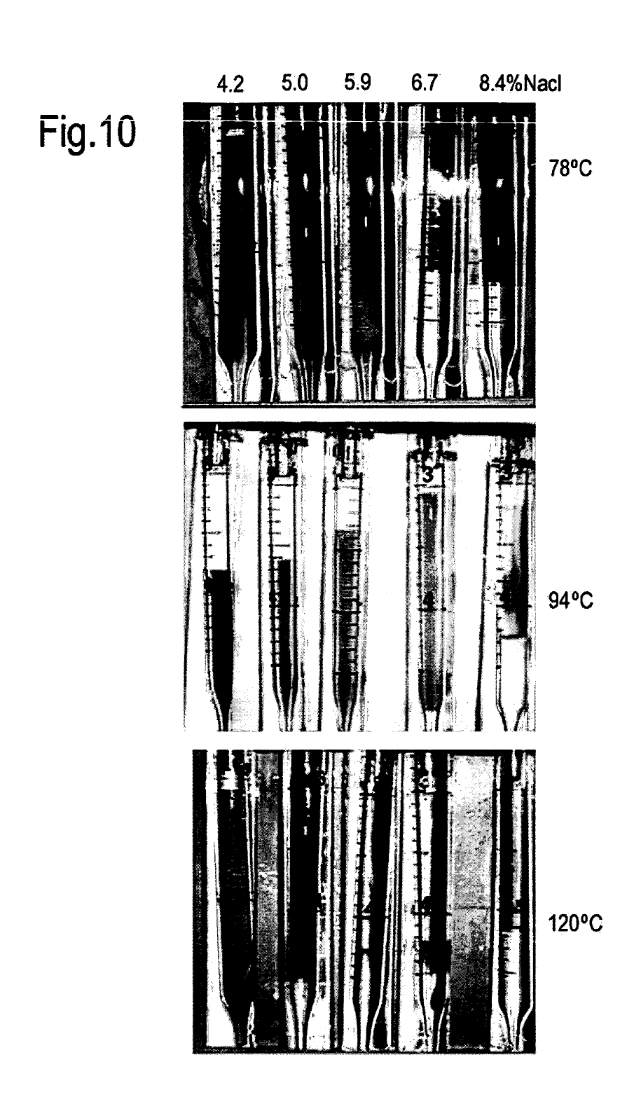

Aqueous NaCl solutions of internal olefin sulfonates (IOSs) frequently exhibit the opposite trend, being multiphase at low temperatures and single phase at high temperatures for fixed salinity. Solubility decreases with increasing salinity at constant temperature. An example of such behavior is shown in FIG. 9(a) for a 2% solution of IOS with C20-24 carbon chains.

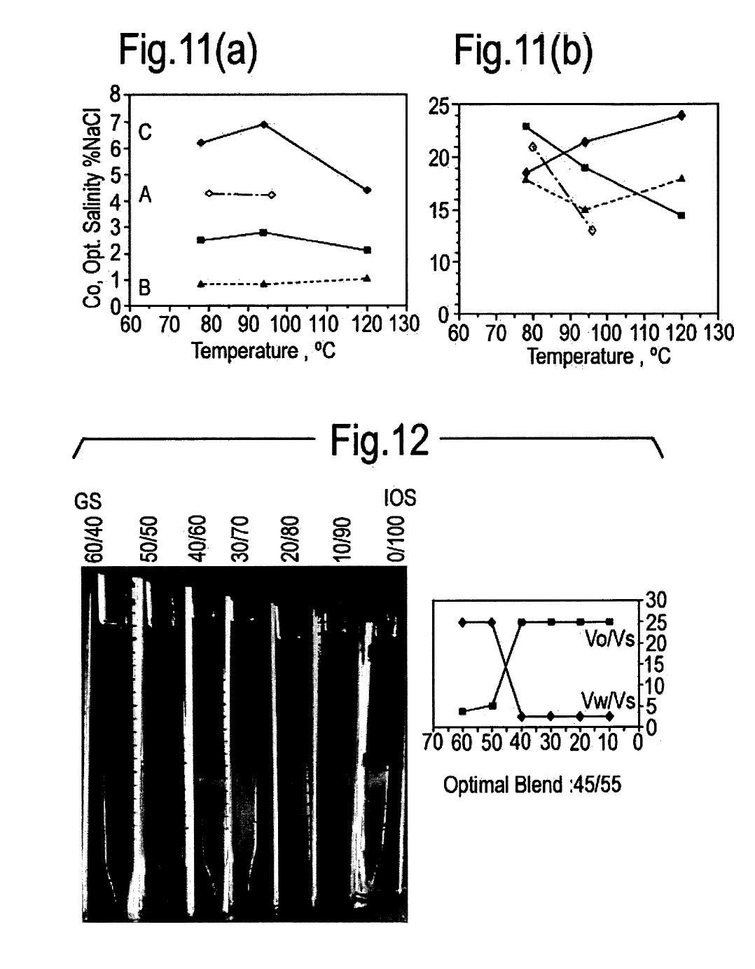

Photographs of salinity scans at 78° C., 94° C. and 120° C. for this surfactant with octane as the oil and no added alcohol are given in FIG. 10. Classical Winsor phase behavior is seen with high solubilization and no VCP. Variation of C_{ø} and (V/Vs) C_{ø} is shown in FIG. 11 (closed diamond curve).

Comparison of FIGS. 9(a) and 11 reveals that single-phase aqueous solutions are found for this surfactant at all three temperatures for salinities up to and including C_{ø} with octane. This single-phase behavior, which makes the solutions suitable for injection in EOR processes, also extends to somewhat lower temperatures though not generally to ambient temperature.

However, a solution containing 4% NaCl, slightly below C_{ø} of 4.5% NaCl at 120° C., is single-phase at 25° C., according to FIG. 9a.

Solubility in aqueous solutions for another IOS C2024 Batch A which has a similar nominal carbon number range, is shown in FIG. 9b. The basic trend of higher solubility in NaCl solutions with increasing temperature is the same, but the line separating soluble and insoluble regions is shifted to lower salinites, indicating that this surfactant is much less soluble. Its values of C_{ø} and (V/Vs)Cø at elevated temperature are shown in FIG. 11 (open diamond curves). The former is about 4% NaCl at both 78° C. and 94° C., roughly 50% lower than corresponding values for IOS C20-24 (Batch C) at these temperatures. It is noteworthy that, according to FIG. 11, two other IOSs, Batch B (closed square curves) and another batch (closed triangle curves) with similar carbon numbers have even lower values of C_{ø} at the same temperatures. Differences also exist in behavior of (V/Vs)Cø although all are high enough to indicate ultralow IFTs. For instance, (V/Vs)Cø for Batch A decreases with increasing temperature, the opposite behavior of that exhibited by Batch C.

The large variations in C_{ø} can be caused by different proportions of individual surfactant species resulting from differences in internal olefin feedstock and in sulfonation reaction conditions. Barnes et al (2008) provide this information for batches A, B, and C (see their Table 1) and discuss the reasons for the differences in behavior. In particular, they note that the percentage of disulfonates, which are more hydrophilic than monosulfonates, increases for the batches in the order B, A, C, the same order as for the increase in values of C_{ø} in FIG. 11. However, several variables are involved, and further research is needed to clarify the effects of feedstock and of variations in the sulfonation process.

FIG. 11b indicates that solutions of Batch A are not suitable for injection at temperatures below 60° C. for any salinity. Moreover, single-phase solutions do not exist near the C_{ø} value of 4% NaCl for any temperature below 100° C.

5. Phase Behavior for an IOS/AGS Blend

As discussed in the preceding section, phase separation of their aqueous NaCl solutions at high temperatures and salinities (cloud point effect) greatly limits application of AGSs and their blends in EOR for such conditions even when they exhibit favorable phase behavior with oil. However, the increase in solubility of IOS's with increasing temperature (FIG. 9) it is proposed herein that AGS/IOS blends may be able to meet the requirements of clear aqueous solutions for injection and phase behavior with oil yielding sufficiently low IFTs to displace oil.

In this section we describe behavior of a blend of b-C16,17-9EO GS, an AGS, with IOS C20-24, an IOS. Behavior of both surfactants when used alone was presented above. For simplicity the focus here is on behavior of this blend at 90° C. with octane as the oil and two different brines, a synthetic seawater whose composition is given in Table 1, and a synthetic reservoir brine having TDS content of approximately 120,000 mg/L. Both these brines contain some Ca⁺² and Mg⁺² ions, in contrast to results presented up to now for NaCl solutions with no hardness.

TABLE 1
Sea Water composition

| Salt | % W/V |
|---|---|
| NaCl | 2.70 |
| CaCl2 | 0.13 |
| MgCl2—6H2O | 1.12 |
| Na2 SO4 | 0.48 |

FIG. 12 shows a photograph of a blend scan, i.e., where the ratio of the two surfactants in the blend is varied, at 90° C. with all samples made by mixing and equilibrating equal volumes of octane and a 2% w/v surfactant solution in the synthetic reservoir brine. C_{ø} occurs at a blend composition between 50/50 and 40/60 of AGS/IOS because the former exhibits Winsor I and the latter Winsor II phase behavior. That is, blends with high contents of AGS are under-optimum and those with high contents of IOS overoptimum for these conditions. (V/Vs) C_{ø} is about 15. When the aqueous phase is made with synthetic seawater, all blend compositions exhibit Winsor I behavior at 90° C., as would be expected with the much lower TDS content. Phase behavior with octane for intermediate salinities and temperatures resulting from mixing of a surfactant solution in seawater with the reservoir brine has not been determined.

Phase behavior of all blend compositions (2% w/v) in synthetic seawater, assumed to be the water available for injection in an EOR process, is shown by the solubility map in FIG. 12. Solutions of all blends are transparent, single-phase solutions at 25° C. However, at 70° C. only blends containing at least 50% AGS are transparent. At 90° C., taken to be reservoir temperature in this example, only blends containing 50%-80% AGS are transparent, i.e., the cloud point has been reached at 90% and 100% AGS, and two liquid phases coexist. That is, addition of 105 in this case allows single-phase solutions to exist for some blends at reservoir temperature, even though this temperature is above the cloud point of the AGS. It is noteworthy that solutions of the 105 itself are not transparent single phases at temperatures above 70° C. This behavior, which may seem surprising in that solubility increases with increasing temperature in NaCl solutions (FIG. 9a), is presumably caused by the presence of hardness in the seawater. Further study of this behavior is desirable. In any case the greater solubility exhibited by some blends than by the individual surfactants at 90° C. (and higher temperatures) demonstrates a synergism between these two surfactants with respect to mutual solubility.

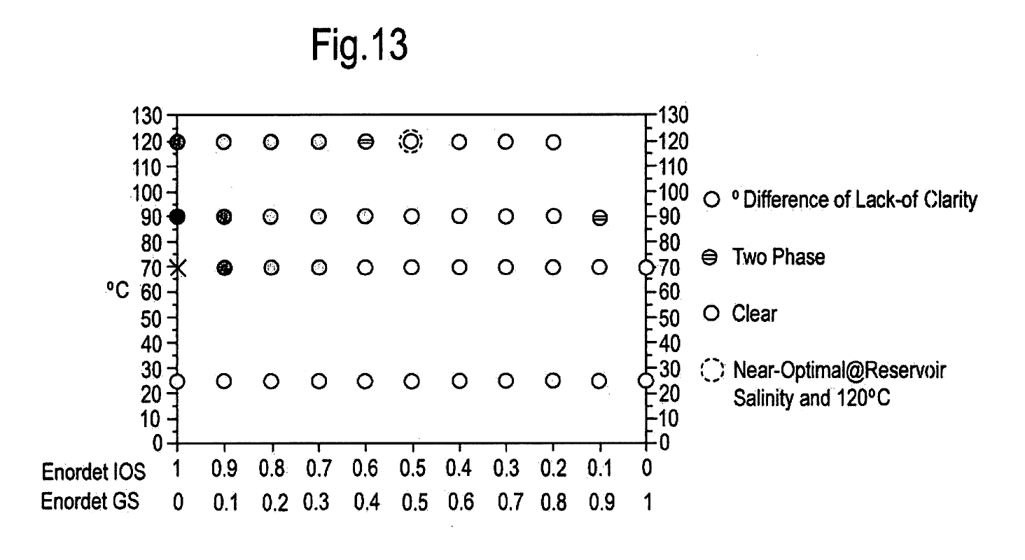

FIG. 13 shows that the 50/50 blend in seawater is soluble from 25C to reservoir temperature of 90° C. and is only slightly under-optimum with octane at 90° C. Thus, it could be a suitable choice for injection in an EOR process. It is not unusual to inject at slightly under-optimum conditions to assure that over-optimum conditions are avoided, where surfactant partitions into the oil and may be retarded or even trapped, thus making the surfactant ineffective in maintaining low IFT at the displacement front.

Of course, once the injected solution enters the reservoir it may, after most of the oil in a region surrounding the wellbore has been displaced, mix with reservoir brine before encountering substantial amounts of oil and forming microemulsions. As a result, the injected blend may experience higher salinities during and after it is heated to reservoir temperature. The solution of the 50/50 blend in synthetic reservoir brine at 90° C. is somewhat cloudy but does not (at least in glass pipettes) exhibit separation into two bulk phases. Experiments have not been conducted with mixtures of seawater and synthetic reservoir brine at 90° C. to determine the degree of mixing with reservoir brine required to produce cloudiness. However, if cloudiness is a problem, it may be possible to remove it by adding a small amount of a paraffinic oil of high molecular weight to convert the micelles of the cloudy solution into a transparent oil-in-water microemulsion (Maerker and Gale 1992).

This example indicates that use of suitable blends of AGS and IOS surfactants is a highly promising approach for designing surfactant IOR processes for high-temperature, high-salinity reservoirs. The reservoir brine in this case has a TDS content of approximately 120,000 mg/L. Blends for high-temperature reservoirs with more saline brines can be developed by using surfactants having higher values of C_{ø}, e.g., having hydrophobes with shorter carbon chains than those in this example.

6. Conclusions

Many AGS/n-octane/NaCl brine systems exhibit classical Winsor phase behavior with no added alcohol or other cosolvents for temperatures between about 85° C. and 120° C. Optimal salinities from less than 1% NaCl to more than 20% NaCl have been observed with suitable choice of hydrophobe and alkoxy chain type (EO or PO) and chain length. Oil solubilization is high, indicating ultralow IFTs near optimal conditions. Maps such as FIGS. 2, 9, and 3 provide an important resource for selection and design of appropriate surfactants and surfactant blends (AGS/IOS blends).

A limitation of AGS surfactants is that their aqueous saline solutions separate into two liquid phases at elevated temperatures. An EOR process would be compromised if such separation were to occur for an injected surfactant solution before it entered the reservoir and advanced far enough to mix with crude oil. Hence, blends of AGS and IOS surfactants allow for overcoming this limitation while still providing good ability to achieve ultralow IFTs and displace oil. IOSs having a wide range of optimal salinities at high temperatures can be produced by varying internal olefin feedstock and conditions of the sulfonation reaction.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

1. A hydrocarbon recovery composition comprising a combination of an internal olefin sulfonate (IOS) and an alkoxy glycidyl sulfonate (AGS).

2. The composition of claim 1, wherein the IOS is selected from one or more IOS having a chain length selected from the group consisting of: C15-C18; C20-C24; and C24-C28.

3. The composition of claim 1, wherein the IOS has a chain length of greater than C20.

4. The composition of claim 1, wherein the IOS has a chain length of C20-C24.

5. The composition of claim 1, wherein the AGS is an ethoxylated glycidyl sulfonate.

6. The composition of claim 1, wherein the AGS is an ethoxylated glycidyl sulfonate with an ethoxy chain length of between 1 and 9.

7. The composition of claim 1, wherein the AGS is a propoxylated glycidyl sulfonate.

8. The composition of claim 1, wherein the AGS is a propoxylated glycidyl sulfonate with a propoxy chain length of between 1 and 6.

9. The composition of claim 1, wherein the AGS is selected from one or more AGS having an alcohol hydrophobe chain length selected from the group consisting of: C12,13; C12-15; and C16,17.

10. The composition of claim 1, wherein the AGS is selected from one or more of the group selected from: a C12,13 linear alcohol-ethoxy-3 glycidyl sulfonate; a C12-15 linear alcohol-ethoxy-7 glycidyl sulfonate a C16,17 branched alcohol-ethoxy-3 glycidyl sulfonate; a C16,17 branched alcohol-ethoxy-9 glycidyl sulfonate; C12,13 linear alcohol-propoxy-3 glycidyl sulfonate; C12,13 linear alcohol-propoxy-7 glycidyl sulfonate; and C16,17 branched alcohol-propoxy-3 glycidyl sulfonate.

11. The composition of claim 1, wherein the ratio of IOS to AGS in the composition is between about 60:40 and about 20:80% w/w.

12. The composition of claim 1, wherein the ratio of IOS to AGS in the composition is between about 50:50 and about 20:80% w/w.

13. The composition of claim 1, wherein the ratio of IOS to AGS in the composition is between about 45:55 and about 20:80% w/w.

14. The composition of claim 1, wherein the ratio of IOS to AGS in the composition is about 40:60% w/w.

15. The composition of claim 1, wherein the composition further comprises water.

16. The composition of claim 1, wherein the composition further comprises sea water.

17. The composition of claim 1, wherein the composition further comprises brine.

18. A hydrocarbon recovery composition comprising surfactant and water, wherein the surfactant comprises a combination of an internal olefin sulfonate (IOS) with a chain length of greater than C20 and an alkoxy glycidyl sulfonate (AGS) selected from an ethoxylated glycidyl sulfonate and a propoxylated glycidyl sulfonate.

19. The composition of claim 18, wherein the IOS has a chain length of C20-C24

20. The composition of claim 18, wherein the AGS is an ethoxylated glycidyl sulfonate with an ethoxy chain length of between 1 and 9.

21. The composition of claim 18, wherein the AGS is a propoxylated glycidyl sulfonate with a propoxy chain length of between 1 and 6.

22. The composition of claim 18, wherein selected from one or more AGS having an alcohol hydrophobe chain length selected from the group consisting of: C12,13; C12-15; and C16,17.

23. The composition of claim 18, wherein the AGS is selected from one or more of the group selected from: a C12,13 linear alcohol-ethoxy-3 glycidyl sulfonate; a C12-15 linear alcohol-ethoxy-7 glycidyl sulfonate a C16,17 branched alcohol-ethoxy-3 glycidyl sulfonate; a C16,17 branched alcohol-ethoxy-9 glycidyl sulfonate; C12,13 linear alcohol-propoxy-3 glycidyl sulfonate; C12,13 linear alcohol-propoxy-7 glycidyl sulfonate; and C 16,17 branched alcohol-propoxy-3 glycidyl sulfonate.

24. The composition of claim 18, wherein the surfactant is present at a concentration of between about 0.01% and about 5.0% (w/v).

25. The composition of claim 18, wherein the surfactant is present at a concentration of between about 0.1% and about 3.0% (w/v).

26. The composition of claim 18, wherein the surfactant is present at a concentration of between about 1.0% and 5.0% (w/v).

27. The composition of claim 18, wherein the ratio of IOS to AGS in the surfactant is between about 60:40 and about 20:80% w/w.

28. The composition of claim 18, wherein the ratio of IOS to AGS in the surfactant is between about 50:50 and about 20:80% w/w.

29. The composition of claim 18, wherein the ratio of IOS to AGS in the surfactant is between about 45:55 and about 20:80% w/w.

30. The composition of claim 18, wherein the ratio of IOS to AGS in the surfactant is about 40:60% w/w.

31. A method of treating a hydrocarbon containing formation, comprising:
(a) providing a hydrocarbon recovery composition to at least a portion of the hydrocarbon containing formation, wherein the composition comprises a blend of an internal olefin sulfonate (IOS) and an alkoxy glycidyl sulfonate (AGS); and
(b) allowing the composition to interact with hydrocarbons in the hydrocarbon containing formation.

32. The method of claim 31, wherein the IOS is selected from one or more IOS having a chain length selected from the group consisting of: C15-C18; C20-C24; and C24-C28.

33. The method of claim 31, wherein IOS has a chain length of greater than C20.

34. The method of claim 31, wherein the IOS has a chain length of C20-C24.

35. The method of claim 31, wherein the AGS is an ethoxylated glycidyl sulfonate.

36. The method of claim 31, wherein AGS is an ethoxylated glycidyl sulfonate with an ethoxy chain length of between 1 and 9.

37. The method of claim 31, wherein the AGS is a propoxylated glycidyl sulfonate.

38. The method of claim 31, wherein the AGS is a propoxylated glycidyl sulfonate with a propoxy chain length of between 1 and 6.

39. The method of claim 31, wherein the AGS is selected from one or more AGS having an alcohol hydrophobe chain length selected from the group consisting of: C12,13; C12-15; and C16,17.

40. The method of claim 31, wherein the AGS is selected from one or more of the group selected from: a C12,13 linear alcohol-ethoxy-3 glycidyl sulfonate; a C12-15 linear alcohol-ethoxy-7 glycidyl sulfonate a C16,17 branched alcohol-ethoxy-3 glycidyl sulfonate; a C16,17 branched alcohol-ethoxy-9 glycidyl sulfonate; C12,13 linear alcohol-propoxy-3 glycidyl sulfonate; C12,13 linear alcohol-propoxy-7 glycidyl sulfonate; and C16,17 branched alcohol-propoxy-3 glycidyl sulfonate.

41. The method of claim 31, wherein the ratio of IOS to AGS in the composition is between about 60:40 and about 20:80% w/w.

42. The method of claim 31, wherein the ratio of IOS to AGS in the composition is between about 50:50 and about 20:80% w/w.

43. The method of claim 31, wherein the ratio of IOS to AGS in the composition is between about 45:55 and about 20:80% w/w.

44. The method of claim 31, wherein the ratio of IOS to AGS in the composition is about 40:60% w/w.

45. The method of claim 31, wherein the temperature within the hydrocarbon containing formation is between about 65° C. and about 130° C.

46. The method of claim 31, wherein the temperature within the hydrocarbon containing formation is between about 85° C. and about 120° C.

47. The method of claim 31, wherein the salinity of the hydrocarbon containing formation is between about 1% and about 20%.

48. The method of claim 31, wherein the salinity of the hydrocarbon containing formation is between about 2% and about 15%.

49. (canceled)
